(19) United States
(12) Patent Application Publication
(10) Pub. No.: US 2006/0282332 A1
(43) Pub. Date: Dec. 14, 2006

(54) Method for transmitting a wireless receipt to a personal digital device

(76) Inventors: Gerald W. Pfleging, Batavia, IL (US); Rachel M. Pfleging, Batavia, IL (US); George Paul Wilkin, Bolingbrook, IL (US)

Correspondence Address: Lucent Technologies Inc.;Docket Administrator, Room 3J-219, 101 Crawfords Corner Road, Holmdel, NJ, 07733-3030, US

(21) Appl. No.: 11/116,853

(22) Filed: Apr. 28, 2005

(51) Int. Cl. G07G 1/12; G07G 5/00

(52) U.S. Cl. 705/24

(57) ABSTRACT

The present invention provides a method for transmitting a wireless receipt to a personal digital device. A cash resister determines that a customer with a personal digital device wants a wireless receipt transmitted to the personal digital device. The cash register determines the wireless protocol that the personal digital device utilizes. The cash register then transmits the wireless receipt to the personal digital device utilizing the wireless protocol.

### FIELD OF THE INVENTION

The present invention relates generally to cash registers, and more particularly to a method and apparatus for providing an interface between a cash register and a personal digital device.

### BACKGROUND OF THE INVENTION

Shoppers who purchase products or services are typically given a printed receipt to document their purchase. The receipt includes a list of the products purchased, the price of each product, the total cost for the products, the tax paid, and the date and time of the purchase.

The receipt can be used when a consumer decides to return a product for either a replacement or a refund. In addition, the receipt is required when sending in a rebate request. Consumers often enter the information from a receipt into either a checkbook register or financial management software.

One problem with paper receipts is that they can be lost. Further, the printing on the receipts can be smeared or washed off, and typically degrades over time. A further problem is that the information on the receipt needs to be manually reentered into any financial management software.

Therefore, a need exists for a method for giving a consumer a record of a purchase that does not get lost as easily as a printed receipt. Further, a need exists for a record of a financial transaction that does not degrade over time. In addition, a need exists for a method that allows a consumer to use information from a purchase without having to re-enter the data from a printed receipt.

### BRIEF SUMMARY OF THE INVENTION

The present invention provides a method for transmitting a wireless receipt of a purchase from a cash register to a personal digital device. The wireless receipt on the personal digital device is not lost as easily as a paper receipt. Further, the wireless receipt does not degrade over time, and cannot be smudged or smeared as printed recipes can. In additional, an electronic wireless receipt allows a user to easily transfer the data on the receipt to a computer or other device, for use in a spreadsheet or financial management software.

In accordance with an exemplary embodiment of the present invention, a customer performs a transaction, such as the purchasing of goods or services from a retailer or the like. In a typical scenario, the store representative requests personal identification information from the consumer. The personal identification information can be conveyed verbally or wirelessly from the personal digital device. The personal identification information can include the name, phone number, zip code, customer number, or other identifying information of the consumer. In addition, the personal digital device can transmit payment information wirelessly to the cash register.

In accordance with an exemplary embodiment of the present invention, a customer utilizing a personal digital device can choose whether they would like a printed receipt, an electronic receipt, or both. The cash register determines if the personal digital device wants a wireless receipt. If the customer does not want an electronic receipt, the cash register prints a receipt for the customer, and the process ends.

If the customer wants an electronic receipt, the cash register determines the type of message to send to the personal digital device. The cash register transmits a wireless receipt to the personal digital device utilizing the selected wireless protocol. The wireless receipt is preferably an un-editable digital replica of the printed receipt.

In a further exemplary embodiment, the wireless receipt includes additional information that allows the user of the personal digital device to enter the information into another system. For example, the additional information can be information that is able to be imported into a financial management software.

The message transmitted may be sent in a secure or non-secure manner. For example, the wireless receipt can be encrypted, the system can use a secure ID, or can implement an authentication algorithm.

### BRIEF DESCRIPTION OF THE SEVERAL VIEWS OF THE DRAWINGS

FIG. 1 depicts a wireless receipt transfer system including a personal digital device and a cash register in accordance with an exemplary embodiment of the present invention.

FIG. 2 depicts a flowchart of a method for sending an electronic receipt to a personal digital device in accordance with an exemplary embodiment of the present invention.

### DETAILED DESCRIPTION OF THE INVENTION

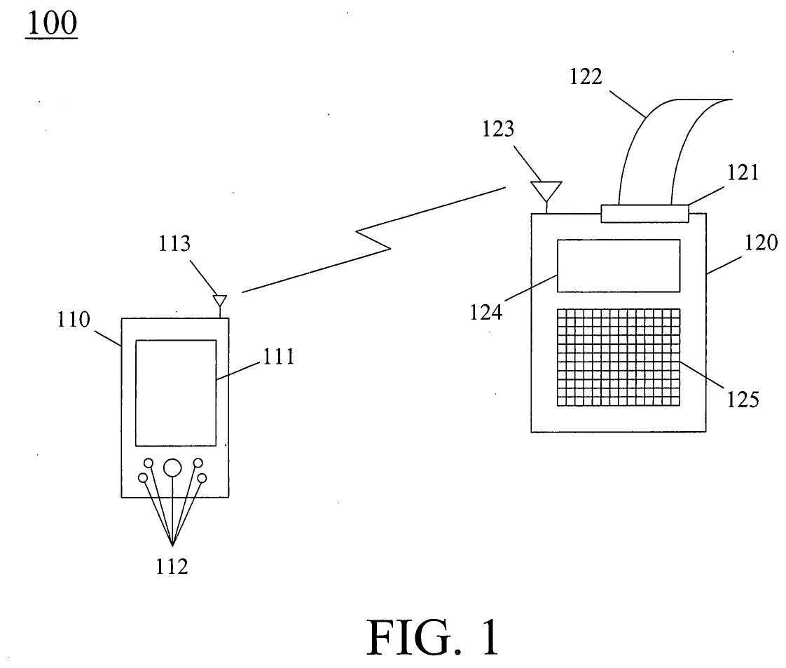

FIG. 1 depicts a wireless receipt transfer system 100 including a personal digital device 110 and a cash register 120 in accordance with an exemplary embodiment of the present invention. Cash register 120 is typically located in a store or other area where goods or services are sold.

Personal digital device 110 is a personal device that is capable of receiving signals from cash register 120 without being physically connected to cash register 120. Personal digital device 120 can be a PDA (Personal Digital Assistant), a computer, a cell phone, a watch, or any other device capable of receiving a wireless signal from another device. As depicted in FIG. 1, personal digital device 110 is a PDA.

Personal digital device 110 includes display 111, input buttons 112, and transceiver 113. Display 111 can be an LCD (Liquid Crystal Display) screen, a TFT (thin-film transistor) technology, CSTN (color super-twist nematic) technology, or any other display capable of presenting an image to a user.

Input buttons 112 are depicted on personal digital device 110. Input buttons 112 allow a user to make selections and enter information into personal digital device 110. Although personal digital device 110 is depicted with input buttons 112, personal digital device 110 may include a variety of means for inputting data or selections into personal digital device 110. For example, personal digital device 110 may include a stylus, a touch screen, a mouse, a keyboard, or any other device capable of inputting data into personal digital device 110.

Transceiver 113 is preferably an antenna that allows personal digital device 110 to communicate with other wireless devices. Transceiver 113 may communicate using IrDA (Infrared Data Association) technology, Bluetooth, 2.5/3.X/4.X generation wireless systems, Wi-Fi, Wi-Max, cellular technology, or any other wireless protocol.

Cash register 120 includes printer 121, transceiver 123, display 124, and input keys 125. Printer 121 is a thermal printer or the like that prints a receipt 122 to be given to a consumer. Display 124 provides an optical representation of the purchases for viewing by a store employee and the consumer. Display 124 can be any suitable technology, such as an LED (Light Emitting Diode), LCD, or the like. Input keys 125 allow input of data into cash register 120.

Transceiver 123 is preferably an antenna that allows communication to and from another wireless device. In an exemplary embodiment, transceiver 123 transmits and receives signals utilizing the same wireless protocol as transceiver 113 on personal digital device 110.

In an exemplary embodiment of the present invention, cash register 120 sends a digital receipt to personal digital device 110. Further, a user can send information from personal digital device 110 to cash register 120. This information may be a shopping list, a list of items that the user is purchasing, or verifying information for the user, such as name, account number, password, account number, zip code, etc. Personal digital device 110 can also transmit payment information to cash register 120, such as a credit or debit card number.

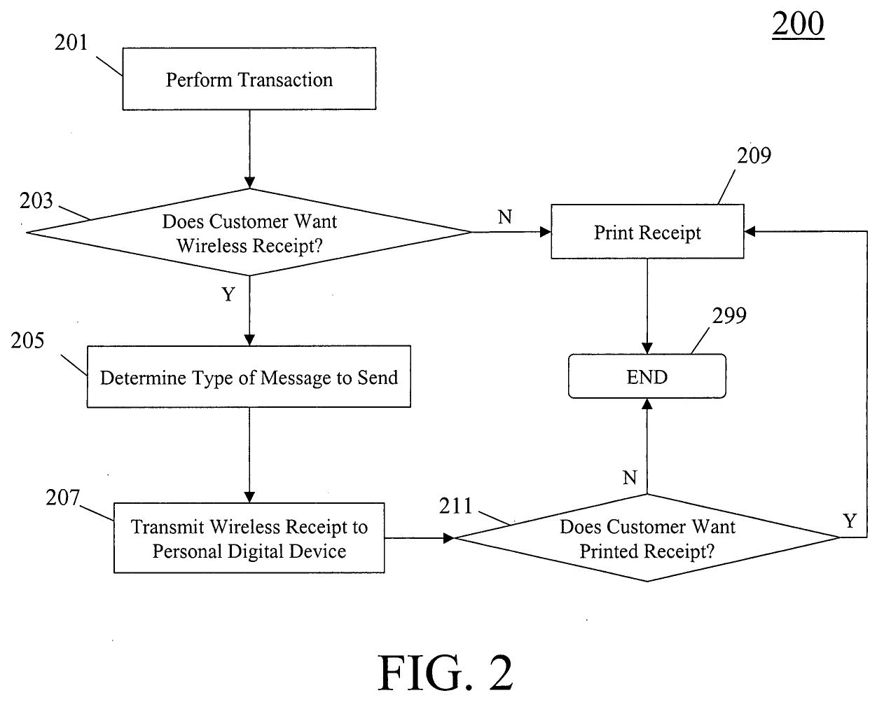

FIG. 2 depicts a flowchart 200 of a method for sending an electronic shopping receipt to a customer device in accordance with an exemplary embodiment of the present invention.

A customer performs (201) a transaction. In accordance with an exemplary embodiment of the present invention, the transaction comprises the purchasing of goods or services from a retailer or the like. For example, cash register 120 can be located in a grocery store, a retail store, or similar retail or wholesale stores. Cash register 120 can be a self-service register or operated by a store representative.

In a typical scenario, the store representative requests personal identification information from the consumer. The personal identification information can be conveyed verbally or wirelessly from personal digital device 110. The personal identification information can include the name, phone number, zip code, customer number, or other identifying information of the consumer. In addition, personal digital device 110 can transmit payment information wirelessly to cash register 120, such as a credit card number or debit card number. An encryption key can also be transmitted, to provide security for the consumer.

In typical applications, at the conclusion of the purchase, cash register 120 prints a receipt 122 utilizing printer 121. The receipt is then given to the customer, who can keep the printed receipt for later inputting into a check register, and also to provide proof of purchase of the goods or services. In accordance with an exemplary embodiment of the present invention, a customer utilizing personal digital device 110 can choose whether they would like a printed receipt, an electronic receipt, or both.

Cash register 120 determines (203) if personal digital device 110 wants a wireless receipt. In an exemplary embodiment, the store employee operating cash register 120 asks the consumer if a wireless receipt is desired. In a further exemplary embodiment, personal digital device 110 sends a wireless signal to cash register 120 to indicate that a wireless receipt is desired. If the customer does not want an electronic receipt as determined at step 203, cash register 120 prints (209) a receipt for the customer, and the process ends (299).

If the customer wants an electronic receipt as determined at step 203, cash register 120 determines (205) the type of message to send to personal digital device 110. The wireless protocol can be chosen by the consumer or the store employee, in which case the wireless protocol to be used in communicating the wireless receipt from cash register 120 to personal digital device 110. In a further exemplary embodiment, personal digital device 110 and cash register 120 employ handshaking or other techniques to determine which wireless protocol should be used to transfer information therebetween. For example, at the end of a transaction, cash register 120 may send out a ping signal for each of the wireless protocols that it supports. Cash register 120 then waits to determine if it receives a response back from a personal digital device. This response would indicate to cash register 120 which protocol should be used to transmit the wireless receipt to personal digital device 110.

The step of determining the type of message to send may also include the determination of other factors. For example, cash register 120 can determine whether the wireless receipt should be encrypted, whether the wireless receipt should be a copy of the printed receipt, whether the wireless receipt should include additional information, and the electronic format of the wireless receipt.

Cash register 120 transmits (207) a wireless receipt to personal digital device 110 utilizing the selected wireless protocol, such as IrDA (Infrared Data Association), Bluetooth, 2.5/3.X/4.X generation wireless systems, Wi-Fi, Wi-Max, or cellular technology. The wireless receipt is preferably an un-editable digital replica of the printed receipt. In this exemplary embodiment, the wireless receipt could be a Portable Document Format (PDF) file, a Joint Photographic Experts Group (JPEG) file, a Tagged Image File Format (TIFF) file, a protected Microsoft Word document, or any other un-editable file.

In a further exemplary embodiment, the wireless receipt includes additional information that allows the user of personal digital device 110 to enter the information into another system. For example, the additional information can be information that is able to be imported into a financial management software, such as Quicken. In this example, the additional information is in Quicken Interchange Format (QIF). Alternately, the additional information could be in Open Finance Exchange (OFX) format.

The message transmitted may be sent in a secure or non-secure manner. For example, the wireless receipt can be encrypted, the system can use a secure ID, or can implement an authentication algorithm.

Cash register 120 determines (211) if the customer wants a printed receipt in addition to the wireless receipt. The consumer may want the printed receipt as a duplicate, a copy, or for manual entering into financial management software. If the consumer does not want a printed receipt, the process ends. If the consumer wants a printed receipt in addition to the wireless receipt, cash register 120 prints (209) the wireless receipt and the process ends (299). While this invention has been described in terms of certain examples thereof, it is not intended that it be limited to the above description, but rather only to the extent set forth in the claims that follow.

We claim:

1. A method for transmitting a wireless receipt to a personal digital device, the method comprising:
determining that a customer wants a wireless receipt transmitted to a personal digital device;
determining the wireless protocol that the personal digital device utilizes; and
transmitting the wireless receipt to the personal digital device utilizing the wireless protocol.

2. A method for transmitting a wireless receipt to a personal digital device in accordance with claim 1, the method further comprising the step of transmitting payment information wirelessly from the personal digital device.

3. A method for transmitting a wireless receipt to a personal digital device in accordance with claim 2, wherein the step of transmitting payment information wirelessly from the personal digital device comprises transmitting an encryption key from the personal digital device.

4. A method for transmitting a wireless receipt to a personal digital device in accordance with claim 1, wherein the step of determining that a customer wants a wireless receipt comprises the step of sending a wireless signal from the personal digital device.

5. A method for transmitting a wireless receipt to a personal digital device in accordance with claim 1, wherein the step of transmitting the wireless receipt to the personal digital device is performed by a cash register, and wherein the step of determining the wireless protocol that the personal digital device utilizes comprises a handshaking protocol between the personal digital device and the cash register.

6. A method for transmitting a wireless receipt to a personal digital device in accordance with claim 1, wherein the step of transmitting the wireless receipt to the personal digital device is performed by a cash register, and wherein the step of determining the wireless protocol that the personal digital device utilizes comprises sending a plurality of ping signals from the cash register, the plurality of ping signals including each of the wireless protocols that the cash register supports.

7. A method for transmitting a wireless receipt to a personal digital device in accordance with claim 1, wherein the step of transmitting the wireless receipt to the personal digital device comprises transmitting the wireless receipt utilizing an encrypted wireless protocol.

8. A method for transmitting a wireless receipt to a personal digital device in accordance with claim 1, wherein the step of transmitting the wireless receipt to the personal digital device comprises transmitting a copy of the printed receipt to the personal digital device.

9. A method for transmitting a wireless receipt to a personal digital device in accordance with claim 1, wherein the step of transmitting the wireless receipt to the personal digital device comprises transmitting an un-editable digital replica of the printed receipt to the personal digital device.

10. A method for transmitting a wireless receipt to a personal digital device in accordance with claim 1, wherein the step of transmitting the wireless receipt to the personal digital device comprises transmitting a wireless receipt that includes additional information to the personal digital device utilizing the wireless protocol.

11. A method for transmitting a wireless receipt to a personal digital device in accordance with claim 10, wherein the additional information is able to be imported into a financial management software.

12. A method for transmitting a wireless receipt to a personal digital device in accordance with claim 1, wherein the step of transmitting the wireless receipt to the personal digital device comprises transmitting a wireless receipt in a secure manner to the personal digital device.

13. A method for transmitting a wireless receipt to a personal digital device in accordance with claim 12, wherein the step of transmitting a wireless receipt in a secure manner to the personal digital device comprises transmitting an encrypted wireless receipt to the personal digital device.

14. A method for transmitting a wireless receipt to a personal digital device in accordance with claim 12, wherein the step of transmitting a wireless receipt in a secure manner to the personal digital device comprises transmitting a wireless receipt utilizing a secure ID to the personal digital device.

15. A method for transmitting a wireless receipt to a personal digital device in accordance with claim 12, wherein the step of transmitting a wireless receipt in a secure manner to the personal digital device comprises transmitting a wireless receipt utilizing an authentication algorithm to the personal digital device.

16. A method for completing a financial transaction between a user having a personal digital device and a cash register, the method comprising:
determining the wireless protocol that the personal digital device utilizes; and
transmitting user information from the personal digital device to the cash register utilizing the wireless protocol.

17. A method for completing a financial transaction in accordance with claim 16, wherein the step of transmitting user information from the personal digital device to the cash register comprises transmitting a shopping list from the personal digital device to the cash register utilizing the wireless protocol.

18. A method for completing a financial transaction in accordance with claim 16, wherein the step of transmitting user information from the personal digital device to the cash register comprises transmitting a list of items that the user is purchasing from the personal digital device to the cash register utilizing the wireless protocol.

19. A method for completing a financial transaction in accordance with claim 16, wherein the step of transmitting user information from the personal digital device to the cash register comprises transmitting verifying information related to the user from the personal digital device to the cash register utilizing the wireless protocol.

20. A method for completing a financial transaction in accordance with claim 16, wherein the step of transmitting user information from the personal digital device to the cash register comprises transmitting electronic payment information from the personal digital device to the cash register utilizing the wireless protocol.
